(19) United States
(12) Patent Application Publication
(10) Pub. No.: US 2024/0287409 A1
(43) Pub. Date: Aug. 29, 2024

(54) CHELATE-AMPHOTERIC SURFACTANT LIQUID CONCENTRATES AND USE THEREOF IN CLEANING APPLICATIONS

(71) Applicant: NOURYON CHEMICALS INTERNATIONAL B.V., Amsterdam (NL)

(72) Inventors: Sorel MURESAN, Stenungsund (SE); Josmary Alejandra VELÁSQUEZ CANO, Västerlanda (SE); Olof BORGLAND, Stenungsund (SE)

(73) Assignee: NOURYON CHEMICALS INTERNATIONAL B.V., Amsterdam (NL)

(21) Appl. No.: 18/574,442

(22) PCT Filed: Jun. 30, 2022
(86) PCT No.: PCT/EP2022/068098

§ 371 Date: Dec. 27, 2023

Related U.S. Application Data
(60) Provisional application No. 63/216,619, filed on Jun. 30, 2021.

(51) Int. Cl. C11D 1/94; C11D 1/14; C11D 1/62; C11D 1/66; C11D 1/90; C11D 3/20; C11D 3/33; C11D 3/37; C11D 3/48

(52) U.S. Cl. CPC C11D 1/94; C11D 3/2086; C11D 3/33; C11D 3/3788; C11D 3/48; C11D 1/146; C11D 1/62; C11D 1/662; C11D 1/90

(57) ABSTRACT

The present disclosure relates to a liquid concentrate useful for cleaning applications, wherein the liquid concentrate comprises (a) one or more chelates selected from aminocarboxylate chelates and non-aminocarboxylate chelates; and (b) one or more amphoteric surfactants selected from amphoteric surfactants having the formula (I):

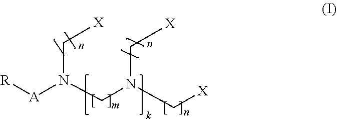

wherein R, A, X, k, m, and n are as described herein. Methods of preparing the liquid concentrate are also disclosed, as are cleaning pods and pouches containing the liquid concentrate, and methods of using the liquid concentrate or the cleaning pods and pouches in a method of cleaning a surface, for example, laundry, kitchenware, and hard surfaces.

### PRIORITY CLAIM

This application is a U.S. National-Stage entry under 35 U.S.C. § 371 based on International Application No. PCT/EP2022/068098, filed Jun. 30, 2022, which was published under PCT Article 21(2) and which claims priority to U.S. Provisional Application No. 63/216,619, filed Jun. 30, 2021, the entire contents of which are all hereby incorporated herein by reference.

### FIELD OF THE DISCLOSURE

The present disclosure relates to liquid concentrates comprising chelates and amphoteric surfactants and to the use of the liquid concentrates for cleaning applications.

### BACKGROUND OF THE DISCLOSURE

As is well-known in the art, many surfactants are too hydrophobic to be soluble in water. Attempts to introduce such surfactants to water can result in cloudy or hazy solutions. In order to solubilize such surfactants, typically a hydrotrope, for example, an amphoteric surfactant, must be added. Often such hydrophobe-hydrotrope combinations remain insufficiently soluble in water to permit formulation as highly concentrated aqueous liquids. This inability to formulate these hydrophobe-hydrotrope combinations as highly concentrated aqueous liquids complicates transportation and storage, and increases costs. Concentrated products need less energy to manufacture and transport and require less packaging. For example, super concentrated liquid detergents are about three times more concentrated than regular liquid detergents. Containers are smaller, use less plastic and are less costly to ship. As a consequence, highly concentrated products tend to be better for the environment.

U.S. Pre-Grant Publication No. 2020/0283701 describes solid cleaning compositions comprising alkali metal carbonate alkalinity source(s), amino carboxylic acid chelant(s), amphoteric surfactant(s), polyacrylate polymer(s), and anionic surfactant(s), but excluding hydroxide alkalinity. According to the publication, liquid cleaning products present various challenges in transporting and storage and, therefore, it can be desirable to replace liquid formulations with solid cleaning compositions. The publication acknowledges, however, that providing solid formulations that have both shelf-stability and provide liquid use compositions that are also stable for extended periods of time can be difficult to provide, while maintaining (or exceeding) cleaning performance. Data are provided in support of the invention therein allegedly showing that solid compositions containing specific combinations of aminocarboxylic acid chelants and amphoteric surfactants give equivalent or superior cleaning performance to liquid compositions containing unspecified chelant and surfactant combinations.

International Publication No. WO 2007/0141635 describes detergent formulations alleged to have a low impact on the environment. Sequestering agents described as being useful in the formulations include iminodisuccinic acid tetrasodium salt (IDS) and N,N-diacetic glutamic acid tetrasodium salt (GLDA). The publication teaches the sequestering agent acts mainly as a calcium and magnesium lime controller, in order to avoid lime to precipitate upon clothes and hard surfaces both as carbonates and as insoluble fatty acids esters. The sequestering agents may be combined with anionic, non-ionic, and amphoteric/zwitterionic surfactants. Liquid concentrates are not mentioned.

Compositions comprising DISSOLVINE® GL-47-S (glutamic acid, N,N-diacetic acid, tetra sodium salt), ETHYLAN® 1008 (C10 alcohol ethoxylate), AMPHOLAK® YJH-40 (sodium capryliminodipropionate), and 73-95% water were used to illustrate certain principles in a lecture entitled “Multifunctional hydrotropes as essential cleaning ingredients,” presented by Dr. Sorel Muresan to the VIII International Conference for Household Industry, held in Warsaw, Poland, on May 8, 2018. Liquid concentrates are not mentioned.

It is an object of the present disclosure to provide highly concentrated liquids for use in cleaning applications. In addition, other objects, desirable features and characteristics will become apparent from the subsequent summary and detailed description, and the appended claims, taken in conjunction with the accompanying drawings and this background.

### BRIEF SUMMARY

The present disclosure relates in one embodiment to a liquid concentrate comprising:
(a) one or more chelates selected from the group consisting of aminocarboxylate chelates and non-aminocarboxylate chelates; and
(b) one or more amphoteric surfactants selected from the group consisting of amphoteric surfactants having the formula (I):

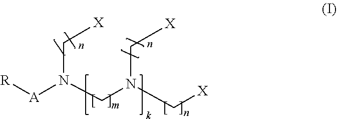

wherein
R is a C5-C22 linear or branched, saturated or non-saturated, substituted or unsubstituted hydrocarbon group,
A is

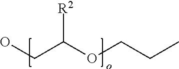

or CH₂,
each X, independently, is H, COOM or SO₃M, with at least one X in the molecule being COOM or SO₃M,
each R², independently, is H, CH₃, or C₂H₅,
k=0-3, suitably 0 or 1,
each m, independently, is 2-6, suitably 2-4, suitably 2 or 3,
each n, independently, is 1-6, suitably 1-3, suitably 1 or 2, if n>1 then the alkylene group can be substituted with an alkyl group,
o=0-40, suitably 0-20, suitably 0-10, and
each M, independently, is selected from H and any cation M+, whereby an oxygen attached to said cation is negatively charged and whereby the sum of all positive charges equals the sum of all negative charges.

In various embodiments, the components (a) and (b) synergize in the context of cleaning, permitting the formulation of highly concentrated liquid concentrates as described in greater detail hereinbelow.

The present disclosure relates in another embodiment to a cleaning pod or pouch comprising the liquid concentrate described herein.

The present disclosure relates in another embodiment to a method of preparing the liquid concentrate described herein, which method comprises mixing components (a) and (b).

The present disclosure relates in yet another embodiment to a method of cleaning a surface to be cleaned comprising the following steps:
(a) providing the liquid concentrate described herein or the pod or pouch described herein;
(b) combining the liquid concentrate or the pod or pouch with water to form a diluted cleaning solution; and
(c) applying the diluted cleaning solution to a surface to be cleaned.

### Definitions

As used herein, the terms “synergize” or “synergy” mean the addition of the one or more chelates described herein to a formulation comprising the one or more amphoteric surfactants described herein alone or optionally in combination with the one or more fatty alcohol alkoxylates increases the cloud point of the resulting formulation compared to the cloud point of the formulation prior to the addition of the one or more chelates.

As used herein, the term “added water” means water added to the composition as a separate ingredient. Thus “added water” is to be distinguished from “intrinsic water” already present in many possible composition ingredients, for example, 50% NaOH intrinsically containing 50% by weight of water.

As used herein, the term “synthetic” means not occurring naturally.

As used herein, the term “natural” means occurring naturally.

As used herein, the term “manufactured polymer” means a polymer not occurring in nature, but rather prepared by synthetic techniques. The term embraces both “hybrid polymer” and “graft polymer” as defined herein below.

As used herein, the term “hybrid polymer” means a polymer containing a backbone chain containing both synthetic and natural monomer residues.

As used herein, the term “graft polymer” means a polymer containing a backbone chain, which may itself be a synthetic homopolymer, a natural homopolymer, or a synthetic/natural copolymer, to which backbone synthetic and/or natural monomer chains are attached.

As used herein, the term “saccharide” means a unit structure of a carbohydrate. Saccharides typically exist as a ring (“closed-chain form”) or in a short chain conformation (“open-chain form”), and typically contain 4-6 carbon atoms.

As used herein, the term “oligosaccharide” means a chain of saccharide units from 1 to 20 saccharide units in length.

As used herein, the term “polysaccharide” means a chain of saccharide units more than 21 saccharide units in length.

As used herein, the term “substantially eliminated” means with increasing preference, compared to a starting quantity, less than 10% remaining, or less than 5% remaining, or less than 2% remaining, or less than 1% remaining, or completely free of what was eliminated.

As used herein, the term “substantially devoid” means, compared to a precursor, containing less than 10% remaining, or less than 5% remaining, or less than 2% remaining, or less than 1% remaining, or completely free of what was contained in the precursor that has been eliminated.

### BRIEF DESCRIPTION OF THE DRAWINGS

The present disclosure will hereinafter be described in conjunction with the following drawing FIGURES, wherein like numerals denote like elements, and:

FIG. 1 is a graph showing the effect on cloud point of a base formulation containing 6% BEROL® 260 and 6% active hydrotrope as a function of increasing concentrations of X % DISSOLVINE® GL-47-S (glutamic acid, N,N-diacetic acid, tetra sodium salt).

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

A limiting factor in regard to the ability to provide a highly concentrated liquid cleaning product is the solubility of the formulation ingredients in the smaller amount of water utilized in the concentrate as compared to, for example, the ready-to-use formulation. Typically, a highly concentrated liquid detergent will be diluted with water in a ratio of 1:10 to 1:100 to obtain the end-use formulation. Thus, compared to the end-use formulation, the highly concentrated liquid detergent contains at a minimum 10 to 100 times less water. As a result of the lower water content, the water solubility of formulation ingredients typically must be optimized if the highly concentration liquid detergent is to become a reality.

For example, hydrophobic surfactants, for example, C8-C14 branched and/or linear, saturated and/or unsaturated alcohol ethoxylates with 3-8 EO, are not soluble in water. An attempt to introduce the hydrophobic surfactant to water will produce a cloudy solution. Depending on the quantity of water, this cloudy solution might be clarified, i.e., the “cloud point” exceeded, by adding a hydrotrope, for example, an amphoteric surfactant. A problem is that, generally, adding other ingredients to the formulation (salts, electrolytes, polymers, etc.) decreases the cloud point. Greater quantities of hydrotrope must then be added in an attempt to compensate. At some point, no amount of hydrotrope will be sufficient to solubilize all the formulation components yet still provide a stable concentrate.

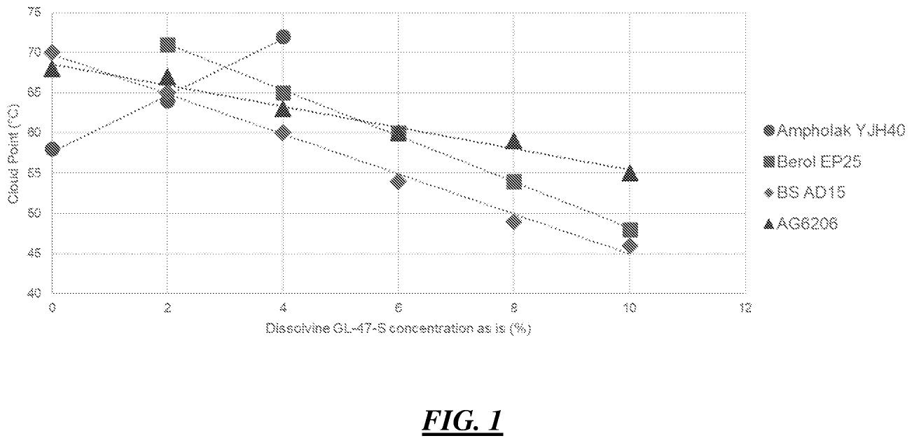

Despite the fact that chelates have no known solubilization effect on nonionics and, in fact, usually decrease the solubility of nonionics as shown in FIG. 1, unexpectedly a combination of components (a) and (b) as herein described is a better solubilizer than components (a) or (b) alone. Since the resulting combination is better able to solubilize additional components, such as the optional one or more fatty alcohol alkoxylates and the optional one or more manufactured polymers, the amount of added water needed to solubilize the additional components can be significantly reduced. This discovery has enabled us to provide highly concentrated liquid cleaning formulations as described herein that find practical beneficial use in cleaning applications, for example by introducing an additional cleaning ingredient such as a nonionic primary surfactant and/or a hybrid polymer.

In one embodiment, a cleaning product according to the present disclosure comprises:
(a) one or more of the chelates described hereinabove;
(b) one of more of the amphoteric surfactants of formula (I) described hereinabove;
(c) optionally one or more fatty alcohol alkoxylates;
(d) optionally one or more manufactured polymers;
(e) optionally one or more adjunct ingredients;
(f) optionally one or more solvents; and
(g) added water.

In one embodiment, the cleaning product according to the present disclosure comprises:
(a) one or more of the chelates described hereinabove;
(b) one or more of the amphoteric surfactants of the formula (I) described hereinabove;
(c) optionally one or more fatty alcohol alkoxylates;
(d) optionally one or more manufactured polymers;
(e) optionally one or more adjunct ingredients;
(f) optionally one or more solvents; and
(g) added water in an amount of 60 wt % or <60 wt %, or <59 wt %, or <58 wt %, or 57 wt %, or <56 wt %, or <55 wt %, or <54 wt %, or <53 wt %, or <52 wt %, or <51 wt %, or <50 wt %, or <49 wt %, or <48 wt %, or <47 wt %, or <46 wt %, or <45 wt %, or <44 wt %, or <43 wt %, or <42 wt %, or <41 wt %, or <40 wt %, or <39 wt %, or <38 wt %, or <37 wt %, or <36 wt %, or <35 wt %, or <34 wt %, or <33 wt %, or <32 wt %, or <31 wt %, or <30 wt %, or <29 wt %, or <28 wt %, or <27 wt %, or <26 wt %, or <25 wt %, or <24 wt %, or <23 wt %, or <22 wt %, or <21 wt %, or <20 wt %, or <19 wt %, or <18 wt %, or <16 wt %, or <15 wt %, or <14 wt %, or <13 wt %, or <12 wt %, or <11 wt %, or <10 wt %, or <9 wt %, or <8 wt %, or <7 wt %, or <6 wt %, but in each at least case 5 wt %, wherein each wt % is based on a total weight of the cleaning product.

In another embodiment, the content of the one or more chelates in the concentrate ranges from 15-50 wt %, based on the total weight of the concentrate, preferably from 15-40 wt %, most preferably from 20-30 wt %.

In another embodiment, the content of the one or more amphoteric surfactants in the concentrate ranges from 5-50 wt %, based on the total weight of the concentrate, preferably from 10-40 wt %, most preferably from 10-40 wt %.

In another embodiment, the added water content of the concentrate ranges from 5-60 wt %, based on the total weight of the concentrate, preferably from 15-60 wt %, most preferably from 20-55 wt %.

In yet another embodiment, the concentrate comprises one or more fatty alcohol alkoxylates in an amount of 0.1-30 wt %, based on the total weight of the concentrate, preferably from 0.1-25 wt %, most preferably from 0.1-20 wt %.

In still another embodiment, the concentrate comprises one or more manufactured polymers in an amount of 0.01-15 wt %, based on the total weight of the concentrate, preferably from 0.1 to 15 wt %, most preferably from 0.1-10 wt %.

In still another embodiment, the concentrate comprises one or more adjunct ingredients, such as polyethylene glycol (PEG), in an amount of 0.01-15 wt %, based on the total weight of the concentrate, preferably from 0.1-15 wt %, most preferably 0.1-10 wt %.

In another embodiment, the concentrate comprises one or more solvents, such as alcohols (e.g., ethanol, isopropanol), triethanolamine, etc., in an amount of 0.01-15 wt %, based on the total weight of the concentrate, preferably from 0.1-15 wt %, most preferably 0.1-10 wt %.

In an especially preferred embodiment, the concentrate comprises one or more chelates in an amount of from 15-50 wt %, based on the total weight of the concentrate, preferably from 15-40 wt %, most preferably from 20-30 wt %; one or more amphoteric surfactants in an amount of from 5-50 wt %, based on the total weight of the concentrate, preferably from 10-40 wt %, most preferably from 10-40 wt %; one or more fatty alcohol alkoxylates in an amount of 0.1-30 wt %, based on the total weight of the concentrate, preferably from 0.1-25 wt %, most preferably from 0.1-20 wt %; and added water in an amount of from 5-60 wt %, based on the total weight of the concentrate, preferably from 15-60 wt %, most preferably from 20-55 wt %.

In another especially preferred embodiment, the concentrate comprises one or more chelates in an amount of from 15-50 wt %, based on the total weight of the concentrate, preferably from 15-40 wt %, most preferably from 20-30 wt %; one or more amphoteric surfactants in an amount of from 5-50 wt %, based on the total weight of the concentrate, preferably from 10-40 wt %, most preferably from 10-40 wt %; one or more manufactured polymers in an amount of 0.01-15 wt %, based on the total weight of the concentrate, preferably from 0.1 to 15 wt %, most preferably from 0.1-10 wt %; and added water in an amount of from 5-60 wt %, based on the total weight of the concentrate, preferably from 15-60 wt %, most preferably from 20-55 wt %.

In a most preferred embodiment, the concentrate comprises one or more chelates in an amount of from 15-50 wt %, based on the total weight of the concentrate, preferably from 15-40 wt %, most preferably from 20-30 wt %; one or more amphoteric surfactants in an amount of from 5-50 wt %, based on the total weight of the concentrate, preferably from 10-40 wt %, most preferably from 10-40 wt %; one or more fatty alcohol alkoxylates in an amount of 0.1-30 wt %, based on the total weight of the concentrate, preferably from 0.1-25 wt %, most preferably from 0.1-20 wt %; one or more manufactured polymers in an amount of 0.01-15 wt %, based on the total weight of the concentrate, preferably from 0.1 to 15 wt %, most preferably from 0.1-10 wt %; and added water in an amount of from 5-60 wt %, based on the total weight of the concentrate, preferably from 15-60 wt %, most preferably from 20-55 wt %.

In another embodiment, the concentrate consists of or includes one or more chelates in an amount of from 15-50 wt %, based on the total weight of the concentrate, preferably from 15-40 wt %, most preferably from 20-30 wt %; one or more amphoteric surfactants in an amount of from 5-50 wt %, based on the total weight of the concentrate, preferably from 10-40 wt %, most preferably from 10-40 wt %; and added water in an amount of from 5-60 wt %, based on the total weight of the concentrate, preferably from 15-60 wt %, most preferably from 20-55 wt %. These concentrates find particular use in automatic dishwashing where chelating power is a key factor.

The chelates of component (a) are well-known in the prior art and are commercially available.

In one embodiment, the chelate is an aminocarboxylate chelate.

In a preferred embodiment, the aminocarboxylate chelate is at least one member selected from the group consisting of methylglycinediacetic acid (MGDA), N,N-dicarboxymethyl glutamic acid (GLDA), N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid triethylenetetraaminehexaacetic acid (TTHA), tetracetyl ethylene diamine (TAED), iminodisuccinic acid (IDS), ethanol diglycine (EDG), and the respective alkali metal, ammonium and substituted ammonium salts thereof.

In another preferred embodiment, the aminocarboxylate chelate is selected from the group consisting of EDTA, GLDA, MGDA, salts thereof, and combinations thereof.

In another embodiment, the chelate is a non-aminocarboxylate chelate. By “non-aminocarboxylate chelate,” it means that the chelate contains carboxylate functionality but does not contain a nitrogen atom.

In a preferred embodiment, the non-aminocarboxylate chelate is a divalent or higher valency carboxylic acid. In an especially preferred embodiment, the non-aminocarboxylate chelate is at least one member selected from the group consisting of citric acid, isocitric acid, 2,3 hydroxycitric acid, tricarballylic acid, ethanetricarboxylic acid (HETA), aconitic acid, succinic acid, maleic acid, fumaric acid, oxaloacetic acid, ketoglutaric acid, butanetetracarboxylic acid, polycarboxylic acid, and the respective alkali metal, ammonium and substituted ammonium salts thereof.

In another preferred embodiment, the non-aminocarboxylate chelate is selected from the group consisting of citric acid and salts thereof.

Generally, the chelate will be a liquid at room temperature and will be mixed with amphoteric surfactant also existing in liquid form at room temperature to form a further liquid that is further processed to form the concentrate. However, solid forms of some chelates are possible as evident, for example, from WO 2020/127349. Accordingly, one embodiment of the present disclosure contemplates using the chelate in solid form. Combining solid chelate with liquid amphoteric surfactant may lead in the first instance to a pasty formulation that may be useful in this form itself or diluted with a small quantity of water to yield the concentrate described herein. In an especially preferred embodiment of this type, the chelate is selected from the group consisting of MGDA, GLDA, citric acid, and salts thereof.

Further, as noted above, U.S. Pre-Grant Publication No. 2020/0283701 describes solid cleaning compositions comprising alkali metal carbonate alkalinity source(s), amino carboxylic acid chelant(s), amphoteric surfactant(s), polyacrylate polymer(s), and anionic surfactant(s), but excluding hydroxide alkalinity. According to the teaching, the compositions described therein do not include hydroxide alkalinity sources such as, for example, alkali metal hydroxide, e.g., potassium or sodium hydroxide. Many available chelates contain alkali metal hydroxide. Accordingly, the present disclosure relates in another embodiment to a concentrate as described herein comprising hydroxide alkalinity, especially alkali metal hydroxide, particularly potassium or sodium hydroxide.

The amphoteric surfactant of formula (I) is known, for example, from WO 2019/215023, the contents of which are hereby incorporated herein by reference.

In addition, some of the amphoteric surfactants of formula (I) are commercially available and sold under the AMPHOLAK® (Nouryon), Lakeland® (Lakeland Laboratories Limited) and LIBRATERIC® (Libra Chemicals) tradenames.

In one embodiment, in the amphoteric surfactant of formula (I), at least one M is not and most preferably all M are not H.

In another embodiment, in the amphoteric surfactant of formula (I), all M are H.

In one preferred embodiment, at least one M is and most preferably all M are an alkaline (earth) metal ion, such as Mg²⁺, Ca²⁺, NH₄⁺, K⁺ or Na⁺.

In another embodiment, at least one M is selected from K⁺ or Na⁺.

In another embodiment, all M groups are selected from K⁺ or Na⁺. This embodiment provides economic advantages and avoids complex formulation.

In one embodiment R is from a natural source, such as derived from oleyl, coco, castor, or tallow fatty acids.

In another embodiment R is lauryl, (iso)tridecyl or (iso)dodecyl.

In another embodiment R is a C6-C10 linear or branched, saturated or non-saturated hydrocarbon group. Such products were found to be easily synthesized, very effective and have a favourable excitoxicity profile.

The amphoteric surfactants can be made in a conventional way by reacting an amine or polyamine, suitably a (poly)amine with a primary amine group, with acrylic acid, typically followed by adjusting the pH. Amphoteric surfactants produced in this way have the advantage that they are salt-free, which is a benefit since it makes aqueous formulations of the products less corrosive, which is an advantage in some applications. Thus, in one embodiment, the present disclosure relates to the use of amphoteric surfactants that are salt-free.

In another embodiment, the present disclosure relates to the use of amphoteric surfactants that are in the form of salts, for example, sodium chloride salts that can be produced, preferably, by reaction with monochloroacetic acid (MCA).

In another embodiment, the amphoteric surfactant is used at a pH<7 where the product is in the cationic form with all M=H and one or more of the nitrogen atoms being protonated. At this pH, a suitable counter ion X is present, which can be any negatively charged ion, for example Cl⁻, CH₃—O—SO₃, CO₃²⁻, or HCO₃⁻ in an amount to have a formulation wherein the total of positive and negative charges is equal.

As demonstrated below in the examples, the addition of liquid amphoteric surfactant to the liquid chelate in some cases causes the viscosity of the combined solution to decrease, relative to the initial liquid chelate alone, in a concentration dependent manner. It is observed that the reduction of a diluted formulation to a concentrate usually causes the viscosity of the concentrating formulation to increase significantly to the point that the viscosity becomes too high to handle the concentrated formulation. Thus, it is a particular advantage that was discovered using the disclosed systems it is possible to prepare concentrates exemplified by lower viscosities that remain free-flowing and easily processable. Accordingly, in one embodiment, the present disclosure contemplates a combination of (a) the chelate described herein and (b) the amphoteric surfactant described herein, wherein the combination has a viscosity that is decreased at room temperature compared to the chelate alone.

Fatty alcohol alkoxylates are also known, for example, from WO 2006/079598, and commercially available, for example, under the BEROL® and ETHYLAN® brands available from Nouryon. An embodiment of the present disclosure contemplates concentrates that comprise one or more fatty alcohol alkoxylates. Suitable fatty alcohol alkoxylates are those of the formula (II):

R—(PO)x(EO)y(PO)zH (II)
wherein
R is a C8-20 branched or branched, saturated or unsaturated hydrocarbon group, preferably C8-20 alkyl, most preferably C8-12;
PO is a propyleneoxy unit;
EO is an ethyleneoxy unit;
X is 0-5, preferably 0-4, and most preferably 0-2;
y 1-20, preferably 1-12, more preferably 2-8, and most preferably 2-5; and
Z 0-5, preferably 0-4, more preferably 0-2, and most preferably 0.

Thus, in one embodiment, in addition to the 1-20 ethyleneoxy units, the C₈-C₂₀-alcohol alkoxylates may also contain up to 5 propyleneoxy units. The number of propyleneoxy units, when present, may be as small as 0.1 mole PO per mole alcohol. The ethyleneoxy units and the propyleneoxy units may be added randomly or in blocks. The blocks may be added to the alcohol in any order. The alkoxylates may also contain an alkyl group with 1-4 carbon atoms in the end position. Preferably, the alkoxylates contain 2-8 ethyleneoxy units and 0-2 propyleneoxy units. The alkyl group of the nonionic surfactants may be linear or branched, saturated or unsaturated. Suitable linear nonionic surfactants are C₉-C₁₁ alcohol+4, 5 or 6 moles of EO, Cu alcohol+3, 4, 5, 6, 7 or 8 moles of EO, tridecyl alcohol+4, 5, 6, 7 or 8 moles of EO, and C₁₀-C₁₄ alcohol+8 moles of EO+2 moles of PO. Suitable branched nonionic surfactants are 2-ethylhexanol+3, 4 or 5 moles of EO, 2-ethylhexanol+2 moles of PO+4, 5 or 6 moles of EO, 2-propylheptanol+3, 4, 5 or 6 moles of EO and 2-propylheptanol+1 mole of PO+4 moles of EO. Another example is 2-butyloctanol+5, 6 or 7 moles of EO. Wherever the degree of alkoxylation is discussed, the numbers represent molar average numbers.

In one embodiment, such fatty alcohol alkoxylates are C8-C20 branched and/or linear, saturated and/or unsaturated alkoxylates, especially C8-C16 branched or linear, saturated or unsaturated alcohol ethoxylates with 3-8 EO.

In one preferred embodiment, the concentrate comprises one or more fatty alcohol alkoxylates of the formulae (III) or (IV), wherein formula (III) is:

R—O(CH₂CH₂O)ₙH (III)
wherein
R is a C8-20 branched or branched, saturated or unsaturated hydrocarbon group; and
n represents 3-8;
and formula (IV) is:

R—O(CH₂CH₂O)ₙ(CH₂CH(CH₃)O)ₘH (IV)
wherein
R is a C8-20 branched linear or branched hydrocarbon group;
m represents 3-8; and
n represents 2-4;

In an especially preferred embodiment, the concentrate comprises one or more fatty alcohol alkoxylates of the formula (III).

In a more preferred embodiment, the concentrate comprises one or more fatty alcohol alkoxylates of the formula (III), wherein R represents C8-C14 hydrocarbon, especially C8, C10, or C9-C11, or C12-C14.

In another especially preferred embodiment, the concentrate comprises one or more fatty alcohol alkoxylates of formula (IV).

In a more preferred embodiment, the concentrate comprises one or more fatty alcohol alkoxylates of formula (IV), wherein R represents C8-C16 hydrocarbon, especially C6 or C12-C16.

Various manufactured polymers are known in the prior art built from a combination of synthetic and naturally-derived materials according to well-known methods, wherein the naturally-derived materials are utilized as chain transfer agents. These manufactured polymers are advantageous over the synthetic polymers that had been utilized prior to their development because the manufactured polymers are at least partially derived from renewable natural sources and, therefore, have an improved renewability and biodegradability profile than their wholly synthetic counterparts. An embodiment of the present disclosure contemplates concentrates that comprise one or more manufactured polymers.

In one embodiment, the manufactured polymer is a hybrid copolymer. Known polymer precursors of this type are described, for example, in U.S. Pat. No. 7,666,963, the entire contents of which are hereby incorporated herein by reference.

In one embodiment, the manufactured polymer is a sulfonated graft copolymer. Known polymer precursors of this type are described, for example, in U.S. Pat. No. 8,674,021, the entire contents of which are hereby incorporated herein by reference.

In one embodiment, the manufactured polymer is a low molecular weight graft copolymer. Known polymer precursors of this type are described, for example, in U.S. Pat. No. 8,227,381, the entire contents of which are hereby incorporated herein by reference.

In one embodiment, the manufactured polymer is a graft dendrite copolymer. Known polymer precursors of this type are described, for example, in U.S. Pat. No. 9,051,406, the entire contents of which are hereby incorporated herein by reference.

In one embodiment, the manufactured polymer is a hybrid dendrite copolymer. Known polymer precursors of this type are described, for example, in U.S. Pat. No. 9,988,526, the entire contents of which are hereby incorporated herein by reference.

In a preferred embodiment, the manufactured polymer is at least one member selected from the group consisting of ALCOGUARD® H5941 (a hybrid synthetic-natural copolymer) and ALCOGUARD® H5240 (a hybrid synthetic-natural copolymer), both of which are available from Nouryon.

It has been found that cleaning products containing manufactured polymers are subject to discoloration, particularly in conditions of elevated temperature (e.g., 20-40° C. and above) and alkaline pH (above pH 7), and further that the source of this discoloration is believed to be a Maillard reaction occurring between terminal aldehyde functionality on the saccharide portion of these polymers with residual proteins/amino acids and perhaps other moieties present from the polysaccharide source. Further, it has also been found that excessively low or high pH (e.g., less than pH 3 or higher than pH 8) can also cause depolymerization of polysaccharide chains especially during the polymerization process. Depolymerization of the polysaccharide chains, in turn, increases the number of aldehyde-containing end groups. Consequently, when employing manufactured polymers susceptible to such discoloration, it is prudent to take steps to substantially eliminate the aldehyde functionality and/or to maintain the pH of the concentrate at a value between 3-7. Techniques for reducing the aldehyde functionality, including addition of hydrogen peroxide and/or sodium borohydride are taught in U.S. Provisional Application No. 63/191,185, filed May 20, 2021, the entire contents of which are incorporated herein by reference.

In one embodiment, wherein the concentrate comprises a manufactured polymer, the manufactured polymer is substantially free of terminal saccharide aldehyde functionality.

In another embodiment, wherein the concentrate comprises a manufactured polymer, the concentrate is formulated to a pH between about 3 to about 7.

It has also been found that manufactured polymers incorporating enzyme degraded polysaccharides can impart performance advantages, including improved anti-redeposition in laundry and improved calcium carbonate inhibition which gives better anti-encrustation in laundry and minimizes filming in automatic dishwash applications.

Most polysaccharides from any source can be degraded in the manner envisioned herein, including waxy maize and dent corn starch, potato starch, wheat starch, sago starch, pea starch, tapioca starch, and maltodextrins of, for example, DE 1 to DE 24, or DE 1 to DE 18, or DE 1 to DE 10, or DE 1 to DE 5.

If raw starch is the starting material, the starch particles may be swollen and broken prior to enzyme degradation through any number of methods known to those skilled in the art, including jet or batch cooking.

Many enzymes are available for use in degrading polysaccharides, including alpha- and beta-amylase, gluco-amylase, and pullulanase, with alpha-amylase being preferred for the present disclosure. Any one of these enzymes can be used alone or in combination with others and the degree of degradation is controlled using techniques known to those skilled in the art. The preferred embodiment utilizes alpha-amylase to produce the alpha-limit dextrin (i.e., material that has undergone full degradation until no further substantial change in molecular weight distribution is obtained).

Degradation is typically performed on a starch dispersion or solution in water, with the concentration of polysaccharide on a dry basis selected as convenient for handling and subsequent polymerization. The reaction temperature is typically between 50 and 100° C., though lower temperatures could be used.

Though the pH of the solution will be adjusted based on the particular enzyme being used, if alpha-amylase is being used, the pH of the dispersion or solution is typically around pH 5.5-6.5. This can be obtained through either adjustment with an acid or base, or a buffer solution can be used.

Calcium may be added to the dispersion or solution, typically in the amount of 50-100 ppm calcium ion on dispersion/solution weight. Those skilled in the art will recognize that the action of some enzymes may benefit from the presence of calcium. The calcium is often present in millimolar quantities and can stabilize the enzyme against heat. In any process involving the enzymatic degradation of starch, considerations should be made to whether calcium in necessary, and in what quantities.

The amount of enzyme dosed to the starch dispersion or solution will depend on the strength of the particular enzyme material and batch being used. The amount of enzyme used and the amount of cooking time in the presence of the enzyme can be varied but is often selected as to be sufficient for enzyme catalyzed hydrolysis to the alpha limit. Sometimes Kilo Novo Units (KNU) are used as a measure of the expected degradation in given conditions with a given amount of starch material. One KNU(T) is the amount of alpha-amylase which, under standard conditions (pH 7.1; 37° C.) dextrinizes 5.26 g starch dry substance (Merck Amylum soluble No. 9947275 or equivalent) per hour.

The action of the enzyme may be stopped by reducing the pH to about pH 5 or below, for example, with an acid. In most of the reactions addition of acrylic acid to start the polymerization reaction will stop the enzyme degradation.

Degrading starch or starch derivatives by alpha-amylase enzyme to its alpha limit leads to digestion of the polysaccharide at regular intervals, producing a narrow range of digested fragments. Enzyme degradation maximizes the oligomeric degree of polymerization (DP) or number of repeat units 4, 5, 6 content while minimizing the DP 1 and 2 content for increased anti-redisposition performance and carbonate inhibition performance when used in subsequent processing. When these digested fragments are, in turn, introduced to a polymer precursor mixture, they are incorporated into the manufactured polymer in the subsequent polymerization.

The enzyme degraded starches preferably have a sum of DP 1 and DP 2 less than 30 more preferably less than 25, more preferably less than 20 and most preferably less than 16, and a preferably a sum of DP 4, 5 and 6 greater than 15, more preferably greater than 25, more preferably greater than 30 and most preferably greater than 35.

In one embodiment, the concentrate comprises a manufactured polymer prepared from enzyme-degraded starch.

In another embodiment, the concentrate comprises one or more biocides.

In one embodiment, the biocides is fatty amine or derivative thereof, particularly a quaternary ammonium compound, having utility for control of bacteria, fungi, viruses, and algae in disinfection or preservation applications.

Suitable biocides are selected from the group consisting of Arquad® 2.10-50 (didecyldimethyl ammonium chloride), Arquad® 2.10-70 HFP (didecyldimethyl ammonium chloride), Arquad® 2.10-80 (didecyldimethyl ammonium chloride), Arquad® C-35 (cocotrimethyl ammonium chloride), Arquad® MCB-50 (C12-C16 alkylbenzyl dimethyl ammonium chloride), Arquad® MCB-50 PO (c) (C12-C16 alkylbenzyl dimethyl ammonium chloride), Arquad® MCB-80 (C12-C16 alkylbenzyl dimethyl ammonium chloride), Arquad® MCB-80 E (C12-C16 alkylbenzyl dimethyl ammonium chloride), Arquad® MC 210 (C12-C16 alkylbenzyl dimethyl ammonium chloride Didecyldimethyl ammonium chloride), Triameen® Y12D (dodecyl dipropylene triamine), Triameen® Y12D PO (c) (dodecyl dipropylene triamine), and Triameen® Y12D-30 (dodecyl dipropylene triamine), and mixtures thereof, and combinations thereof.

Where biocides are present in the concentrate, they are preferably present in amounts of 0.01 to 10% by weight, most preferably 0.1 to 7% by weight, or 0.1 to 6% by weight, or 0.1 to 5% by weight, based in each case on a total weight of the concentrate.

In one embodiment, the concentrate comprises one or more adjunct ingredients.

Any suitable adjunct ingredient suitable for use in cleaning formulations can be added to the concentrates described herein. Useful adjunct ingredients include, for example, aesthetic agents, anti-filming agents, anti-redeposition agents, anti-spotting agents, anti-graying agents, beads, binders, bleach activators, bleach catalysts, bleach stabilizing systems, bleaching agents, brighteners, buffering agents, builders, carriers, chelants, clay, color speckles, control release agents, corrosion inhibitors, dish care agents, disinfectant, dispersant agents, draining promoting agents, drying agents, dyes, dye transfer inhibiting agents, enzymes, enzyme stabilizing systems, fillers, free radical inhibitors, fungicides, germicides, hydrotropes, opacifiers, perfumes, pH adjusting agents, pigments, processing aids, silicates, soil release agents, suds suppressors, surfactants, stabilizers, thickeners, zeolite, and mixtures thereof.

The adjunct ingredients can further include builders, enzymes, surfactants other than those previously described herein, bleaching agents, bleach modifying materials, acids, corrosion inhibitors and aesthetic agents.

Suitable builders include, but are not limited to, alkali metals, ammonium and alkanol ammonium salts of polyphosphates, alkali metal silicates, alkaline earth and alkali metal carbonates, nitrilotriacetic acids, polycarboxylates, (such as citric acid, mellitic acid, succinic acid, oxydisuccinic acid, polymaleic acid, benzene 1,3,5-tricarboxylic acid, carboxymethyl oxysuccinic acid, and water-soluble salts thereof), phosphates (e.g., sodium tripolyphosphate), and mixtures thereof.

Suitable enzymes include, but are not limited to, proteases, amylases, cellulases, lipases, carbohydrases, bleaching enzymes, cutinases, esterases, and wild-type enzymes.

Suitable surfactants include, but are not limited to, nonionic surfactants, anionic surfactants, cationic surfactants, ampholytic surfactants, zwitterionic surfactants, and mixtures thereof.

Suitable bleaching agents include, but are not limited to, common inorganic/organic chlorine bleach (e.g., sodium or potassium dichloroisocyanurate dihydrate, sodium hypochlorite, sodium hypochloride), hydrogen-peroxide releasing salt (such as, sodium perborate monohydrate (PB1), sodium perborate tetrahydrate (PB4)), sodium percarbonate, sodium peroxide, and mixtures thereof.

Suitable bleach-modifying materials include but are not limited to hydrogen peroxide-source bleach activators (e.g., TAED), bleach catalysts (e.g. transition containing cobalt and manganese).

Suitable acids include, but are not limited to, acetic acid, aspartic acid, benzoic acid, boric acid, bromic acid, citric acid, formic acid, gluconic acid, glutamic acid, hydrochloric acid, lactic acid, malic acid, nitric acid, sulfamic acid, sulfuric acid, tartaric acid, and mixtures thereof.

Suitable corrosion inhibitors, include, but are not limited to, soluble metal salts, insoluble metal salts, and mixtures thereof. Suitable metal salts include, but are not limited to, aluminum, zinc (e.g., hydrozincite), magnesium, calcium, lanthanum, tin, gallium, strontium, titanium, and mixtures thereof. Suitable aesthetic agents include, but are not limited to, opacifiers, dyes, pigments, color speckles, beads, brighteners, and mixtures thereof.

With the addition of suitable adjuncts, the concentrates described herein can be adapted for subsequent use as automatic dishwashing detergent compositions (e.g., builders, surfactants, enzymes, etc.), light-duty liquid dishwashing compositions, laundry compositions such as, compact and heavy-duty detergents (e.g., builders, surfactants, enzymes, etc.), and/or hard surface cleaning compositions (e.g., zwitterionic surfactants, germicides, etc.).

Suitable adjunct ingredients are disclosed in one or more of the following: U.S. Pat. Nos. 2,798,053; 2,954,347; 2,954,347; 3,308,067; 3,314,891; 3,455,839; 3,629,121; 3,723,322; 3,803,285; 3,929,107, 3,929,678; 3,933,672; 4,133,779, 4,141,841; 4,228,042; 4,239,660; 4,260,529; 4,265,779; 4,374,035; 4,379,080; 4,412,934; 4,483,779; 4,483,780; 4,536,314; 4,539,130; 4,565,647; 4,597,898; 4,606,838; 4,634,551; 4,652,392; 4,671,891; 4,681,592; 4,681,695; 4,681,704; 4,686,063; 4,702,857; 4,968,451; 5,332,528; 5,415,807; 5,435,935; 5,478,503; 5,500,154; 5,565,145; 5,670,475; 5,942,485; 5,952,278; 5,990,065; 6,004,922; 6,008,181; 6,020,303; 6,022,844; 6,069,122; 6,060,299; 6,060,443; 6,093,856; 6,130,194; 6,136,769; 6,143,707; 6,150,322; 6,153,577; 6,194,362; 6,221,825; 6,365,561; 6,372,708; 6,482,994; 6,528,477; 6,573,234; 6,589,926; 6,627,590; 6,645,925; and 6,656,900; International Publication Nos. 00/23548; 00/23549; 00/47708; 01/32816; 01/42408; 91/06637; 92/06162; 93/19038; 93/19146; 94/09099; 95/10591; 95/26393; 98/35002; 98/35003; 98/35004; 98/35005; 98/35006; 99/02663; 99/05082; 99/05084; 99/05241; 99/05242; 99/05243; 99/05244; 99/07656; 99/20726; and 99/27083; European Patent No. 130756; British Publication No. 1137741 A; Chemtech, pp. 30-33 (March 1993); J. American Chemical Soc., 115, 10083-10090 (1993); and Kirk Othmer Encyclopedia of Chemical Technology, 3rd Ed., Vol. 7, pp. 430-447 (John Wiley & Sons, Inc., 1979).

In one embodiment, the concentrate is phosphate-free.

In one embodiment, the concentrate or cleaning formulation obtained by diluting the concentrate comprises a phosphate-free builder.

In another embodiment, the concentrate comprises one or more solvents. Suitable solvents include, but are not limited to low molecular weight organic solvents (e.g., primary alcohols, e.g., ethanol, secondary alcohols, monohydric alcohols, polyols, alkanolamines, e.g., triethanol amine, and mixtures thereof), and mixtures thereof with water.

The concentrates of the present disclosure can be used in cleaning applications, for example, in laundry, in cleaning kitchenware, or in cleaning hard surfaces, among other possibilities.

The concentrate can be provided in any suitable form, for example, in water-soluble pouches or pods. If the pouch or pod comprises multiple compartments, the concentrate comprising the chelate, amphoteric surfactant, water, and optional fatty alcohol alkoxylates and/or optional manufactured polymer, but without adjunct ingredients can be provided in one compartment and the adjunct ingredients in a separate compartment so that ingredients of the concentrate and the adjunct ingredients will mix when the pouch or pod is dissolved in water.

In one embodiment, the concentrate is used in connection with cleaning laundry.

In another embodiment, the concentrate is used to clean a kitchen item, preferably selected from cookware, dishware, cups, glasses, and eating utensils.

In another embodiment, the cleaning is carried out in an automatic dishwasher, and the item to be cleaned and the concentrate are introduced to the dishwasher. The cleaning of kitchen items in automatic dishwashers is well-known to persons skilled in the art and details of such use are omitted here. Typically, a rinse aid composition is provided as a liquid formulation separate from the concentrate and introduced to the dishwasher via a dedicated liquid rinse aid compartment. In an especially preferred embodiment, the rinse aid is a polyester polyquaternary (PEPQ) compound in accordance with the teaching in U.S. Provisional Application No. 63/189,818, filed May 18, 2021, the entire contents of which are hereby incorporated herein by reference.

In another embodiment, the kitchen item cleaning is performed manually, for example, using the concentrate per se or using a cleaning composition obtained by diluting the concentrate with water.

In yet another embodiment, the surface to be cleaned is a hard surface.

In one embodiment, the hard surface is a bathroom or kitchen surface. As described in U.S. Provisional Application No. 63/189,818, the incorporation of PEPQs may impart a beneficial stickiness of the cleaning formulation to vertical surfaces without adversely affecting the ability of the cleaning formulation to be sprayed.

Accordingly, in a preferred embodiment, the concentrate includes a suitable amount of a PEPQ; or a cleaning formulation obtained by a process comprising diluting the concentrate with water comprises a suitable amount of a PEPQ.

In an especially preferred embodiment, the PEPQ is BEROL® SurfBoost® RA (C16-C18 polyester polyquaternary compound) or ARMOFLOTE® 763 (C16-C18 polyester polyquaternary compound).

### EXAMPLES

The present disclosure will now be described in greater detail with reference to the following non-limiting examples.

### Example 1: Solubilization of Nonionics

### Experiment A

100 g of DISSOLVINE® GL-47-S (glutamic acid, N,N-diacetic acid, tetra sodium salt) (as is) was added to 250 ml beaker. In the first screening phase, 0.5 g of surfactant was added to the beaker with DISSOLVINE® GL-47-S (glutamic acid, N,N-diacetic acid, tetra sodium salt) and mixed for a few minutes with a magnetic stirrer. If any of the formulation remained clear, more of the same surfactant was added stepwise with a mixing step in between each addition. The appearance and clarity of the formulation was observed between each addition of surfactant. Also, the viscosity of some of the formulations was measured with a Brookfield viscometer.

DISSOLVINE® GL-47-S (glutamic acid, N,N-diacetic acid, tetra sodium salt) (as is) is a clear product. The viscosity was measured to 153 cP (sp.2, 30 RPM, room temperature).

An attempt was made to solubilize each of the following surfactants:
Nonionics: AG 6206 (C6 alkylglucoside); BEROL® 175 (C12-C16 alcohol exhoxylate); BEROL® 185 (alcohol ethoxylate propoxylate); BEROL® EP 25 (C8 alcohol ethoxylate); BEROL® 360 (C10 natural alcohol ethoxylate); ETHYLAN® 1008 (C10 alcohol ethoxylate)
Anionics: Sodium laureth sulfate, 2EO, 28% from Julius Hoesch; WITCONATE® AOS-12 (C12 alpha olefin sulfonate)
Cationics: BEROL® R648 NG (quaternary C12-C14 alkyl methyl amine ethoxylate methyl chloride); AROMAX® MCD-W (fractionated coco) dimethylamine oxide)
Amphoterics: AMPHOLAK® YJH-40 (sodium capryliminodipropionate); AMPHOLAK® XCE (coco iminodiglycinate); AMPHOLAK® YCE (sodium cocopropylene-diaminepropionate); AMPHOLAK® 7CX/C (sodium cocoamphopolycarboxylglycinate sodium chloride); AMPHOLAK® XO7/C (oleylamphopolycarboxyglycinate); AMPHOLAK® 7TX (sodium tallowamphopolycarboxylglycinate); LIBRATERIC® BA-70 (2-ethylhexyliminodipropionate disodium salt).

Surprisingly, only the formulation with 0.5 g of AMPHOLAK® YJH-40 (sodium capryliminodipropionate) remained clear, which indicated the formulation was stable. (See also FIG. 1 showing the cloud point decrease with every hydrotrope other than AMPHOLAK® YJH-40 (sodium capryliminodipropionate).)

An attempt was made to ascertain the boundaries of this stability. Accordingly, more AMPHOLAK® YJH-40 (sodium capryliminodipropionate) was added stepwise to the formulation with 0.5 g of AMPHOLAK® YJH-40 (sodium capryliminodipropionate) to achieve AMPHOLAK® YJH-40 (sodium capryliminodipropionate) total weights in grams of 1.0, 1.5, 2.0, 2.5, 3.0, 4.0, 5.0, 7.5, 10.0, 12.5, 15.0, 17.5, 20.0, 25.0, and 30.0. Again, surprisingly, it was discovered that at each weight increase the formulation remained clear and stable. At the same time, viscosity at room temperature decreased somewhat from 103 cP (sp.2 30 RPM) at 7.5 g, to 86 cP (sp.2 30 RPM) at 15.0 g, to 67 cP (sp.2 30 RPM) at 30.0 g.

### Experiment B

An attempt was made to determine if other amphoteric surfactants could be solubilized similarly.

Formulations were made up containing DISSOLVINE® GL-47-S (glutamic acid, N,N-diacetic acid, tetra sodium salt) and various amphoteric surfactants and tested to give the appearance, viscosity, and pH values shown below:

| | Formulation (wt %) | | | | | | |
|---|---|---|---|---|---|---|---|
| | 1-1 | 1-2 | 1-3 | 1-4 | 1-5 | 1-6 | 1-7 |
| DISSOLVINE ® | 50% | 50% | 50% | 50% | 50% | 50% | 50% |
| GL-47-S¹ | | | | | | | |
| AMPHOLAK ® | 50% | | | | | | |
| YJH-40² (40%) | | | | | | | |
| LIBRATERIC ® | | 50% | | | | | |
| BA-70³ | | | | | | | |
| AMPHOLAK ® | | | 50% | | | | |
| XCE⁴ | | | | | | | |
| AMPHOLAK ® | | | | 50% | | | |
| YCE⁵ | | | | | | | |
| AMPHOLAK ® | | | | | 50% | | |
| 7CX/C⁶ | | | | | | | |
| AMPHOLAK ® | | | | | | 50% | |
| XO7/C⁷ | | | | | | | |
| AMPHOLAK ® | | | | | | | 50% |
| 7TX⁸ | | | | | | | |
| Appearance | Clear | Clear | Clear | Clear | Clear | Clear | Clear |
| Viscosity, sp. 3, | 37 cP | 162 cP | 26 cP | 19 cP | 30 cP | 32 cP | 32 cP |
| 30 RPM | | | | | | | |
| pH | 9.27 | 9.26 | 9.37 | 8.91 | 9.58 | 9.55 | 9.64 |
| Surfactant active | 20% | 35% | 20% | 15% | 20% | 20% | 20% |
| content | | | | | | | |
| GLDA active | 23.5% | 23.5% | 23.5% | 23.5% | 23.5% | 23.5% | 23.5% |
| content | | | | | | | |
| Water content | 56.5% | 41.5% | 56.5% | 61.5% | 56.5% | 56.5% | 56.5% |

¹glutamic acid, N,N-diacetic acid, tetra sodium salt (GLDA)
²sodium capryliminodipropionate
³2-ethylhexyliminodipropionate disodium salt
⁴coco iminodiglycinate
⁵sodium cocopropylene-diaminepropionate
⁶sodium cocoamphopolycarboxylglycinate sodium chloride
⁷oleylamphopolycarboxyglycinate
⁸sodium tallowamphopolycarboxylglycinate

Despite significant differences in the chemistries involved, surprisingly all of the formulations were clear and stable (did not separate).

### Experiment C

An attempt was made to determine whether nonionics could be introduced into the chelate-amphoteric systems.

Formulations were made up containing DISSOLVINE® GL-47-S (glutamic acid, N,N-diacetic acid, tetra sodium salt), various amphoteric surfactants, and nonionics and tested to give the appearance, viscosity, and pH values shown below:

| | Formulation (wt %) | | | | | | | |
|---|---|---|---|---|---|---|---|---|
| | 1-8 | 1-9 | 1-10 | 1-11 | 1-12 | 1-13 | 1-14 | 1-15 |
| DISSOLVINE ® | 50 | 50 | 50 | 50 | 50 | 50 | 50 | 50 |
| GL-47-S¹ | | | | | | | | |
| AMPHOLAK ® | 40 | 30 | 20 | 10 | | | | |
| YJH-40² | | | | | | | | |
| LIBRATERIC ® | | | | | 40 | 30 | 20 | 35 |
| BA-70³ | | | | | | | | |
| BEROL ® 360⁴ | 10 | 20 | 30 | 40 | 10 | 20 | 30 | 15 |
| Appearance | Clear | Clear | Turbid | Turbid | Clear | Turbid | Turbid | Clear |
| Viscosity, sp. 3, | 79 cP | 117 cP | — | — | 178 cP | — | — | 167 cP |
| 30 RPM | | | | | | | | |
| pH | 9.40 | 9.52 | 9.69 | 10.22 | 9.43 | 9.55 | 9.65 | 9.47 |
| Surfactant active | 26% | 32% | 38% | 44% | 38% | 41% | 44% | 39.5% |
| content | | | | | | | | |
| GLDA active | 23.5% | 23.5% | 23.5% | 23.5% | 23.5% | 23.5% | 23.5% | 23.5% |
| content | | | | | | | | |
| Water content | 50.5% | 44.5% | 38.5% | 32.5% | 38.5% | 35.5% | 32.5% | 37% |

¹glutamic acid, N,N-diacetic acid, tetra sodium salt (GLDA)
²sodium capryliminodipropionate
³2-ethylhexyliminodipropionate disodium salt
⁴C10 natural alcohol ethoxylate

Surprisingly, the system was loaded with nonionics (BEROL® 360 (C10 natural alcohol ethoxylate)) in both cases of the amphoteric surfactant (AMPHOLAK® YJH-40 (sodium capryliminodipropionate) or LIBRATERIC® BA-70 (2-ethylhexyliminodipropionate disodium salt)).

An attempt was made to load a different nonionic (ETHYLAN® 1008 (C10 alcohol ethoxylate)). Formulations were made up containing DISSOLVINE® GL-47-S (glutamic acid, N,N-diacetic acid, tetra sodium salt), various amphoteric surfactants, and ETHYLAN® 1008 (C10 alcohol ethoxylate) and tested to give the appearance, viscosity, and pH values shown below:

| | Formulation (wt %) | | | | | | | |
|---|---|---|---|---|---|---|---|---|
| | 1-16 | 1-17 | 1-18 | 1-19 | 1-20 | 1-21 | 1-22 | 1-23 |
| DISSOLVINE ® | 50 | 50 | 50 | 50 | 50 | 50 | 50 | 50 |
| GL-47-S¹ | | | | | | | | |
| AMPHOLAK ® | 40 | 30 | 20 | 45 | | | | |
| YJH-40² | | | | | | | | |
| LIBRATERIC ® | | | | | 40 | 30 | 20 | 35 |
| BA-70³ | | | | | | | | |
| ETHYLAN ® | 10 | 20 | 30 | 5 | 10 | 20 | 30 | 15 |
| 1008⁴ | | | | | | | | |
| Appearance | Turbid | Turbid | Turbid | Clear | Clear | Turbid | Turbid | Turbid |
| Viscosity, sp. 3, | — | — | — | 48 cP | 169 cP | — | — | — |
| 30 RPM | | | | | | | | |
| pH | 9.46 | 9.64 | 9.68 | 9.34 | 9.41 | 9.52 | 9.70 | 9.46 |
| Surfactant active | 26% | 32% | 38% | 23% | 38% | 41% | 44% | 39.5% |
| content | | | | | | | | |
| GLDA active | 23.5% | 23.5% | 23.5% | 23.5% | 23.5% | 23.5% | 23.5% | 23.5% |
| content | | | | | | | | |
| Water content | 50.5% | 44.5% | 38.5% | 53.5% | 38.5% | 35.5% | 32.5% | 37% |

¹glutamic acid, N,N-diacetic acid, tetra sodium salt (GLDA)
²sodium capryliminodipropionate
³2-ethylhexyliminodipropionate disodium salt
⁴C10 alcohol ethoxylate

The foregoing shows that it is also possible to solubilize different nonionics in the inventive system.

Since ETHYLAN® 1008 (C10 alcohol ethoxylate) is more hydrophilic compared with BEROL® 360 (C10 natural alcohol ethoxylate), the easier solubilization of BEROL® 360 (C10 natural alcohol ethoxylate) is surprising and unexpected. ETHYLAN® 1008 (C10 alcohol ethoxylate) is made from a C10 branched alcohol while BEROL® 360 (C10 natural alcohol ethoxylate) is made from a C10 linear alcohol. The results obtained could be related with the different packing behavior of these alkyl chains.

It was confirmed that the inventive system operates for other aminocarboxylate chelates, e.g., EDTA, as shown below:

| Formulation (wt %) | 1-24 | 1-25 | 1-26 |
|---|---|---|---|
| EDTA (100%) | 20 | 20 | 20 |
| AMPHOLAK ® YJH-40¹ | 50 | 30 | 30 |
| BEROL ® 360² | | 20 | 15 |
| Demin water | 30 | 30 | 35 |
| Appearance | Clear | Clear | Clear |
| pH | 8.97 | 9.04 | 9.15 |
| Surfactant (active content) | 20% | 32% | 27% |
| EDTA (active content) | 20% | 20% | 20% |
| Water content | 60% | 48% | 53% |

¹sodium capryliminodipropionate
²C10 natural alcohol ethoxylate

It was confirmed that similar good results are achieved with non-aminocarboxylate chelates using citric acid as a representative. Formulations were made up containing citric acid, AMPHOLAK® YJH-40 (sodium capryliminodipropionate), and optionally DISSOLVINE® M-40 (methylglycine, N,N-diacetic acid, trisodium salt) and/or BEROL® 360 (C10 natural alcohol ethoxylate) and tested to give the appearance and pH values shown below:

| Formulation (wt %) | 1-27 | 1-28 | 1-29 | 1-30 | 1-31 |
|---|---|---|---|---|---|
| Citric acid (100%) | 20 | 20 | 10 | 10 | 20 |
| DISSOLVINE ® M-40¹ | | | 25 | 25 | |
| AMPHOLAK ® YJH-40² | 50 | 30 | 50 | 30 | 30 |
| BEROL ® 360³ | | 20 | | 20 | 15 |
| Demin water | 30 | 30 | 15 | 15 | 35 |
| Appearance | Clear | Clear | Clear | Clear | Clear |
| pH | 3.34 | 3.03 | 4.60 | 4.43 | 3.00 |
| Surfactant (active content) | 20% | 32% | 20% | 32% | 27% |
| Citric Acid (active content) | 20% | 20% | 10% | 10% | 20% |
| MGDA (active content) | | | 10% | 10% | |
| Water content | 60% | 48% | 60% | 48% | 53% |

¹methylglycine, N,N-diacetic acid, trisodium salt (MGDA)
²sodium capryliminodipropionate
³C10 natural alcohol ethoxylate

### Example 2: Solubilization of Hybrid Polymers

Interestingly, it was discovered a differential solubilization of hybrid polymers compared to synthetic polymers.

### Experiment A

In a first set of experiments, three base formulations were made up in and spiked with cleaning polymer in the indicated weight percentages of all four ingredients as follows:

| Base | BEROL ® | AMPHOLAK ® | DISSOLVINE ® | Cleaning |
|---|---|---|---|---|
| Formulation | 360¹ | YJH-40² | GL-47-S³ | Polymer |
| 2-1 | 9 | 40 | 50 | 1 |
| 2-2 | 5 | 40 | 50 | 5 |
| 2-3 | 0 | 40 | 50 | 10 |

¹C10 natural alcohol ethoxylate
²sodium capryliminodipropionate
³glutamic acid, N,N-diacetic acid, tetra sodium salt

In this first set of experiments, the cleaning polymers tested were: ALCOGUARD® H5240 (a hybrid synthetic-natural copolymer), ALCOGUARD® H5941 (a hybrid synthetic-natural copolymer), and ALCOSPERSE® 747 (acrylic/styrene copolymer).

At all three weight percentages of the cleaning polymer, the base formulations spiked with both ALCOGUARD® H5240 (a hybrid synthetic-natural copolymer) and ALCOGUARD® H5941 (a hybrid synthetic-natural copolymer) were clear from the outset and remained clear after the passage of two weeks, indicating the formulations were stable.

In contrast, at all three weight percentages of the cleaning polymer, the base formulations spiked with ALCOSPERSE® 747 (acrylic/styrene copolymer) exhibited instability. These formulations took longer to dissolve and when shaken appeared wavy, which is indicative of some immiscibility. The formulations were hazy at first, but by the end of the first week had clarified.

### Experiment B

In a second set of experiments, three base formulations were made up in and spiked with cleaning polymer in the indicated weight percentages of all four ingredients as follows:

| Base | BEROL ® | AMPHOLAK ® | DISSOLVINE ® | Cleaning |
|---|---|---|---|---|
| Formulation | 360¹ | YJH-40² | GL-47-S³ | Polymer |
| 2-4 | 10 | 35 | 50 | 5 |
| 2-5 | 10 | 30 | 50 | 10 |
| 2-6 | 10 | 25 | 50 | 15 |

¹C10 natural alcohol ethoxylate
²sodium capryliminodipropionate
³glutamic acid, N,N-diacetic acid, tetra sodium salt

In this second set of experiments, the cleaning polymers tested were:
ALCOGUARD® H5240 (a hybrid synthetic-natural copolymer), ALCOGUARD® H5941 (a hybrid synthetic-natural copolymer), ALCOSPERSE® 747 (acrylic/styrene copolymer),
ALCOSPERSE® 6195 (a synthetic copolymer), ALCOSPERSE® 787 (hydrophobically modified acrylic copolymer), JLJ20-152 (a synthetic acrylic acid-styrene copolymer), JLJ20-159 (a synthetic acrylic acid-styrene copolymer), JLJ20-164 (a synthetic acrylic acid-styrene copolymer), JLJ20-169 (a synthetic acrylic acid-styrene copolymer), ALCOSPERSE® 602N (sodium polyacrylate), ALCOSPERSE® 412 (acrylic/maleic copolymer), and
ALCOGUARD® 4160 (sulfonated multipolymer).

At all three weight percentages of the cleaning polymer, the base formulations spiked with both ALCOGUARD® H5240 (a hybrid synthetic-natural copolymer) and ALCOGUARD® H5941 (a hybrid synthetic-natural copolymer) were again clear from the outset and remained clear after the passage of two weeks, indicating the formulations were stable.

In contrast, at all three weight percentages of the cleaning polymer, the base formulations spiked with ALCOSPERSE® 747 (acrylic/styrene copolymer) once again exhibited instability. These formulations took longer to dissolve and when shaken appeared wavy, which is indicative of some immiscibility. The formulations were hazy at first, but by the end of the first week had clarified. The same was true of base formulations spiked with ALCOSPERSE® 6195, ALCOSPERSE® 787 (hydrophobically modified acrylic copolymer), ALCOSPERSE® 602N (sodium polyacrylate), ALCOSPERSE® 408 (acrylic/maleic copolymer), ALCOSPERSE® 412 (acrylic/maleic copolymer), and ALCOGUARD® 4160 (sulfonated multipolymer).

At all three weight percentages of the cleaning polymer, the formulations spiked with JLJ20-152, JLJ20-159, JLJ20-164, and JLJ20-169 became hazy shortly after preparation and separated after a few hours forming a two-phase system that was, thus, completely unstable.

The foregoing shows surprisingly and unexpectedly that solubilization of hybrid polymers in the inventive chelate-amphoteric system is easier and leads to stable formulations generally where solubilization of synthetic polymers is more difficult and formation of unstable formulations is likely.

### Example 3: Solubilization of Biocides

It was further discovered that the system is useful to solubilize biocides.

In the experiments reported below, the following are chelants were utilized:
Dissolvine GL-47-S (Glutamic acid, N,N-diacetic acid, tetra sodium salt)
EDTA (2,2′,2″,2′″-(Ethane-1,2-diyldinitrilo)tetraacetic acid)
Citric Acid (2-Hydroxypropane-1,2,3-tricarboxylic acid)

The following amphoterics were also utilized:

Ampholak YJH-40 (Sodium capryliminodipropionate)

The following nonionics were also utilized:

Berol 360 (C10 Natural alcohol ethoxylate)

The following biocides were also utilized:
Arquad® MCB-50 (50% C12-16 Alkylbenzyldimethylammonium chloride (BKC) CAS no: 68424-85-1)
Arquad® MCB-80 (80% C12-16 Alkylbenzyldimethylammonium chloride (BKC) CAS no: 68424-85-1)
Arquad® 2.10-50 (50% Didecyldimethylammonium chloride (DDAC) CAS no: 7173-51-5)
Triameen® Y12D-30 (30% N-(3-aminopropyl)-N-dodecylpropane-1,3-diamine)
Triameen® Y12D (100% N-(3-aminopropyl)-N-dodecylpropane-1,3-diamine)

### Experiment A

The solubility of either 5% or 10% of the indicated biocide was tested in a system comprising 50% chelant (represented by Dissolvine GL-47-S) and the indicated amphoteric as follows:

| | Formulation (wt-%) | | | | | | | | | |
|---|---|---|---|---|---|---|---|---|---|---|
| | 3-1 | 3-2 | 3-3 | 3-4 | 3-5 | 3-6 | 3-7 | 3-8 | 3-9 | 3-10 |
| Dissolvine | 50% | 50% | 50% | 50% | 50% | 50% | 50% | 50% | 50% | 50% |
| GL-47-S | | | | | | | | | | |
| Ampholak | 40% | 45% | 40% | 45% | 40% | 45% | 40% | 45% | 40% | 45% |
| YJH-40 | | | | | | | | | | |
| (40%) | | | | | | | | | | |
| Arquad | 10% | 5% | | | | | | | | |
| MCB-50 | | | | | | | | | | |
| Arquad | | | 10% | 5% | | | | | | |
| MCB-80 | | | | | | | | | | |
| Triameen | | | | | 10% | 5% | | | | |
| Y12D | | | | | | | | | | |
| Triameen | | | | | | | 10% | 5% | | |
| Y12D-30 | | | | | | | | | | |
| Arquad | | | | | | | | | 10% | 5% |
| 2.10-50 | | | | | | | | | | |
| Stability | Clear | Clear | Clear | Clear | Clear | Clear | Clear | Clear | Clear | Clear |
| imme- | * | * | * | * | | | | | | |
| diately | | | | | | | | | | |
| Stability 1 | Clear | Clear | Clear | Clear | Clear | Clear | Clear | Clear | Clear | Clear |
| day | | | | | | | | | | |
| Viscosity, | 36 cP | 48 cP | 76 cP | 60 cP | 160 cP | 76 cP | 48 cP | 48 cP | 72 cP | 60 cP |
| sp. 3, | | | | | | | | | | |
| 30 RPM | | | | | | | | | | |
| pH | 9.19 | 9.27 | 9.21 | 9.17 | 10.14 | 9.86 | 9.68 | 9.33 | 9.17 | 9.16 |
| Surfactant | 20.5% | 21% | 22.5% | 25% | 23% | 26% | 19.5% | 19% | 21.5% | 23% |
| active | | | | | | | | | | |
| content | | | | | | | | | | |
| GLDA | 23.5% | 23.5% | 23.5% | 23.5% | 23.5% | 23.5% | 23.5% | 23.5% | 23.5% | 23.5% |
| active | | | | | | | | | | |
| content | | | | | | | | | | |
| Water | 56% | 55.5% | 54% | 51.5% | 53.5% | 50.5% | 57% | 57.5% | 55% | 53.5% |
| content | | | | | | | | | | |

* The formulations became completely clear after 10-15 minutes.

### Experiment B

The solubility of 5% biocide in a system comprising 50% chelant (represented by Dissolvine GL-47-S), 35% of the indicated amphoteric, and 10% nonionic (represented by Berol 360) as follows was evaluated:

| Formulation (wt-%) | 3-11 | 3-12 | 3-13 | 3-14 | 3-15 |
|---|---|---|---|---|---|
| Dissolvine GL-47-S | 50% | 50% | 50% | 50% | 50% |
| Ampholak YJH-40 | 35% | 35% | 35% | 35% | 35% |
| (40%) | | | | | |
| Arquad MCB-50 | 5% | | | | |
| Arquad MCB-80 | | 5% | | | |
| Triameen Y12D | | | 5% | | |
| Triameen Y12D-30 | | | | 5% | |
| Arquad 2.10-50 | | | | | 5% |
| Berol 360 | 10% | 10% | 10% | 10% | 10% |
| Stability | Clear* | Clear* | Clear* | Clear | Sep |
| immediately | | | | | |
| Stability 1 day | Clear | Clear | Clear | Clear | Clear |
| Viscosity, sp. 3, | 68 cP | 84 cP | 128 cP | 68 cP | 72 cP |
| 30 RPM | | | | | |
| pH | 9.26 | 9.23 | 9.83 | 9.49 | 9.68 |
| Surfactant active | 26.5% | 28.5% | 29% | 25.5% | 27.5% |
| content, including | | | | | |
| biocide | | | | | |
| GLDA active content | 23.5% | 23.5% | 23.5% | 23.5% | 23.5% |
| Water content | 50% | 48% | 47.5% | 51% | 49% |

### Experiment C

The solubility of various biocides in a system comprising 50% chelant (represented by EDTA) and X % of the indicated amphoterics as follows was evaluated:

| | Formulation (wt-%) | | | | | | | | | |
|---|---|---|---|---|---|---|---|---|---|---|
| | 3-16 | 3-17 | 3-18 | 3-19 | 3-20 | 3-21 | 3-22 | 3-23 | 3-24 | 3-25 |
| | Formulation (wt-%) | | | | | | | | | |
| | 3-16 | 3-17 | 3-18 | 3-19 | 3-20 | 3-21 | 3-22 | 3-23 | 3-24 | 3-25 |
| EDTA (100%) | 50% | 50% | 50% | 50% | 50% | 50% | 50% | 50% | 50% | 50% |
| Ampholak YJH-40 | 40% | 45% | 40% | 45% | 40% | 45% | 40% | 45% | 40% | 45% |
| (40%) | | | | | | | | | | |
| Arquad MCB-50 | 10% | 5% | | | | | | | | |
| Arquad MCB-80 | | | 10% | 5% | | | | | | |
| Triameen Y12D | | | | | 10% | 5% | | | | |
| Triameen Y12D-30 | | | | | | | 10% | 5% | | |
| Arquad 2.10-50 | | | | | | | | | 10% | 5% |
| Stability | Clear | Clear | Sep | Sep | Sep | Sep | Clear | Clear | Clear | Clear |
| immediately | | | | | | | | | | |
| Stability 1 day | Clear | Clear | Sep | Sep | Clear | Clear | Clear | Clear | Clear | Clear |
| Viscosity, sp. 3, | 20 | 20 | 20 | 16 | 36 | 24 | 16 | 16 | 20 | 20 |
| 30 RPM | | | | | | | | | | |
| pH | 8.99 | 9.06 | 8.94 | 8.97 | 10.17 | 9.69 | 9.56 | 9.36 | 9.02 | 9.03 |
| Surfactant active | 21 | 20.5 | 20.5 | 27 | 21 | 28 | 17.5 | 21 | 19.5 | 25 |
| content, including | | | | | | | | | | |
| biocide | | | | | | | | | | |
| GLDA active | 20 | 20 | 20 | 20 | 23.5 | 23.5 | 23.5 | 23.5 | 23.5 | 23.5 |
| content | | | | | | | | | | |
| Water content | 59 | 59.5 | 59.5 | 53 | 55.5 | 48.5 | 59 | 55.5 | 57 | 51.5 |

### Experiment D

Finally, the solubility of the indicated biocides in a system comprising 50% chelant (represented by citric acid) and X % of the indicated amphoterics as follows was evaluated:

TABLE 1
50% Citric Acid + x % amphoterics + y % biocide

| | Formulation (wt-%) | | | | | | | | | |
|---|---|---|---|---|---|---|---|---|---|---|
| | 3-26 | 3-27 | 3-28 | 3-29 | 3-30 | 3-31 | 3-32 | 3-33 | 3-34 | 3-35 |
| | Formulation (wt-%) | | | | | | | | | |
| | 3-26 | 3-27 | 3-28 | 3-29 | 3-30 | 3-31 | 3-32 | 3-33 | 3-34 | 3-35 |
| Citric acid (100%) | 50% | 50% | 50% | 50% | 50% | 50% | 50% | 50% | 50% | 50% |
| Ampholak YJH-40 | 40% | 45% | 40% | 45% | 40% | 45% | 40% | 45% | 40% | 45% |
| (40%) | | | | | | | | | | |
| Arquad MCB-50 | 10% | 5% | | | | | | | | |
| Arquad MCB-80 | | | 10% | 5% | | | | | | |
| Triameen Y12D | | | | | 10% | 5% | | | | |
| Triameen Y12D- | | | | | | | 10% | 5% | | |
| 30 | | | | | | | | | | |
| Arquad 2.10-50 | | | | | | | | | 10% | 5% |
| Stability | Clear | Clear | Sep | Sep | Sep | Sep | Clear | Clear | Clear | Clear |
| immediatly | | | | | | | | | | |
| Stability 1 day | Clear | Clear | Sep | Sep | Sep | Sep | Clear | Clear | Clear | Clear |
| Viscosity, sp. 3, | 12 | 12 | 16 | 16 | 20 | 16 | 12 | 12 | 16 | 16 |
| 30 RPM | | | | | | | | | | |
| pH | 2.94 | 3.05 | 2.91 | 2.98 | 3.82 | 3.58 | 3.27 | 3.25 | 2.95 | 3.08 |
| Surfactant active | 21 | 20.5 | 20.5 | 27 | 21 | 28 | 17.5 | 21 | 19.5 | 25 |
| content, including | | | | | | | | | | |
| biocide | | | | | | | | | | |
| GLDA active | 20 | 20 | 20 | 20 | 23.5 | 23.5 | 23.5 | 23.5 | 23.5 | 23.5 |
| content | | | | | | | | | | |
| Water content | 59 | 59.5 | 59.5 | 53 | 55.5 | 48.5 | 59 | 55.5 | 57 | 51.5 |

Collectively, the foregoing establish that it is possible to add up to 10% biocide in the concentrated formulations using a combination of chelates and amphoterics.

While the present disclosure has been described in conjunction with the specific embodiments set forth above, many alternatives, modifications and other variations thereof will be apparent to those of ordinary skill in the art. All such alternatives, modifications and variations are intended to fall within the spirit and scope of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A liquid concentrate comprising:
(a) one or more chelates selected from the group consisting of aminocarboxylate chelates and non-aminocarboxylate chelates; and
(b) one or more amphoteric surfactants selected from the group consisting of amphoteric surfactants having the formula (I): 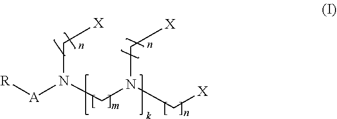
wherein
R is a C5-C22 linear or branched, saturated or non-saturated, substituted or unsubstituted hydrocarbon group,
A is 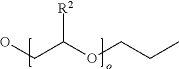
or CH₂,
each X, independently, is H, COOM or SO₃M, with at least one X in the molecule being COOM or SO₃M,
each R², independently, is H, CH₃, or C2H5,
k=0-3,
each m, independently, is 2-6,
each n, independently, is 1-6, wherein if n>1 then the alkylene group is optionally substituted with an alkyl group,
o=0-40, and
each M, independently, is selected from H and any cation M⁺, whereby an oxygen attached to said cation is negatively charged and whereby the sum of all positive charges equals the sum of all negative charges.

2. The liquid concentrate according to claim 1, wherein the one or more chelates comprise at least one aminocarboxylate chelate.

3. The liquid concentrate according to claim 2, wherein the aminocarboxylate chelate is selected from the group consisting of EDTA, GLDA, MGDA, and salts thereof.

4. The liquid concentrate according to claim 1, wherein the one or more chelates comprise at least one non-aminocarboxylate chelate.

5. The liquid concentrate according to claim 4, wherein the non-aminocarboxylate chelate is selected from the group consisting of citric acid and salts thereof.

6. The liquid concentrate according to claim 1, wherein the one or more amphoteric surfactants comprise at least one member selected from the group consisting of sodium cocoamphopolycarboxyglycinate, sodium tallowamphopolycarboxyglycinate, coco iminodiglycinate, sodium cocopropylenediaminepropionate, sodium capryliminodipropionate, coco dipropionate disodium salt, coco dipropionate monosodium salt, coco dipropionate triethanolamine salt, 2-ethylhexyl dipropionate disodium salt, 2-ethylhexyl dipropionate dipotassium salt, cocoamphodipropionate disodium salt, acid addition salts thereof, and salts thereof.

7. The liquid concentrate according to claim 1, which further comprises at least one fatty alcohol alkoxylate.

8. The liquid concentrate according to claim 7, wherein the at least one fatty alcohol alkoxylate is a C8-C14 branched or linear, saturated or unsaturated alcohol alkoxylate.

9. The liquid concentrate claim 1, which further comprises at least one manufactured polymer comprising a synthetic component covalently bonded to a natural component, wherein the natural component comprises oligosaccharide or polysaccharide.

10. The liquid concentrate according to claim 9, wherein the at least one manufactured polymer is at least one members selected from the group consisting of hybrid copolymers, sulfonated graft copolymers, low molecular weight graft copolymers, hybrid dendrite copolymers, and graft dendrite copolymers.

11. The liquid concentrate according to claim 1, which further comprises at least one biocide.

12. The liquid concentrate according to claim 11, wherein the biocide is selected from the group consisting of didecyldimethyl ammonium chloride, cocotrimethyl ammonium chloride, C12-C16 alkylbenzyl dimethyl ammonium chloride, dodecyl dipropylene triamine, and combinations thereof.

13. A cleaning pod or pouch comprising a liquid concentrate according to claim 1.

14. A method of preparing a liquid concentrate according to claim 1, which comprises mixing components (a) and (b).

15. A method of cleaning a surface to be cleaned comprising the following steps:
(a) providing a liquid concentrate according to claim 1;
(b) combining the liquid concentrate with water to form a diluted cleaning solution; and
(c) applying the diluted cleaning solution to a surface to be cleaned.

16. The method according to claim 15, wherein the surface to be cleaned is laundry.

17. The method according to claim 15, wherein the surface to be cleaned is kitchenware.

18. The method according to claim 17, which is performed manually.

19. The method according to claim 17, which is performed in an automatic dishwasher.

20. The method according to claim 15, wherein the surface to be cleaned is a hard surface.
